(19) United States
(12) Patent Application Publication
(10) Pub. No.: US 2011/0099506 A1
(43) Pub. Date: Apr. 28, 2011

(54) Predictive Text Entry for Input Devices

(75) Inventors: Ullas Gargi, Los Altos, CA (US); Richard C. Gossweiler, III, Sunnyvale, CA (US)

(73) Assignee: GOOGLE INC., Mountain View, CA (US)

(21) Appl. No.: 12/912,721

(22) Filed: Oct. 26, 2010

Related U.S. Application Data
(60) Provisional application No. 61/255,050, filed on Oct. 26, 2009.

(51) Int. Cl. G06F 3/048

(52) U.S. Cl. 715/773

(57) ABSTRACT

Methods, systems, and apparatus, including computer program products, for providing predictive text functionality to input devices. In one aspect, a method includes receiving a selection of a first character from a plurality of characters displayed in a virtual representation of an input device; generating one or more first selectable suggestions based on the first character; and displaying the one or more first selectable suggestions proximate to the first character in the virtual representation of the input device. The first selectable suggestions are displayed closer to the first character than any of the plurality of characters normally displayed in the virtual representation of the input device.

### CROSS-REFERENCE TO RELATED APPLICATION

This application claims the benefit under 35 U.S.C. §119(e) of U.S. Patent Application No. 61/255,050, filed Oct. 26, 2009, which is incorporated by reference herein in its entirety.

### BACKGROUND

This specification relates to predictive text entry, and in particular, to modifying user interfaces to include predictive text entry functionality.

Some electronic devices do not have or support a conventional keyboard for text entry. Instead, some of these electronic devices provide a virtual input interface or a virtual representation of an input device (also referred to as a “virtual input device”), e.g., an onscreen keyboard, and a user can use a physical input device such as an Up-Down-Left-Right (UDLR) keypad to navigate to and select keys on the keyboard.

Using a UDLR keypad to navigate through the keys of an onscreen keyboard can require multiple user interactions to traverse various distances across the onscreen keyboard. In addition, as the size of a display of an electronic device decreases, the size of the keys displayed in the onscreen keyboard may also decrease.

### SUMMARY

This specification describes technologies relating to providing predictive text functionality to input devices.

In general, one aspect of the subject matter described in this specification can be embodied in methods that include the actions of receiving a selection of a first character from a plurality of characters displayed in a virtual representation of an input device; generating one or more first selectable suggestions based on the first character; and displaying the one or more first selectable suggestions proximate to the first character in the virtual representation of the input device. The first selectable suggestions are displayed closer to the first character than any of the plurality of characters normally displayed in the virtual representation of the input device. Other embodiments of this aspect include corresponding systems, apparatus, and computer program products.

The foregoing and following embodiments can optionally include one or more of the following features. The first selectable suggestions include input completions. A selectable suggestion is a single character. A selectable suggestion is a sequence of characters. The first character is displayed as one of a grid of characters in the virtual representation, the characters in the grid are displayed separated from each other by blank space and the suggestions are displayed in otherwise blank space in the virtual representation of the input device. The plurality of characters are displayed on two axes on the virtual representation of an input device and the first selectable suggestions are displayed on the two axes. The first selectable suggestions are displayed until a selection is received of one of the first selectable suggestions or a selection is received of one of the characters displayed in the virtual representation of an input device.

The method further includes receiving a selection of a function key displayed in the virtual representation of the input device; generating one or more second selectable suggestions based on the selected function key; and displaying the one or more second selectable suggestions proximate to the selected function key in the virtual representation of the input device.

The method further includes receiving a selection of one of the first selectable suggestions; generating one or more second selectable suggestions based on the first selectable suggestion that was selected; and displaying the one or more second selectable suggestions proximate to a character in the virtual representation of the input device, where the first selectable suggestion that was selected is a sequence of characters, and the character which the one or more second selectable suggestions is displayed proximate to corresponds to a last character in the sequence of characters of the first selectable suggestion that was selected. Receiving a selection of one of the first selectable suggestions includes receiving a navigation input navigating from the representation of the first character in the virtual representation to one of the first selectable suggestions in the virtual representation.

In general, another aspect of the subject matter described in this specification can be embodied in methods that include the actions of receiving a selection of a key displayed in a virtual representation of an input device; generating one or more selectable suggestions based on a character or function that corresponds to the key; and displaying the selectable suggestions proximate to the selected key in the virtual representation of the input device. Other embodiments of this aspect include corresponding systems, apparatus, and computer program products.

In general, another aspect of the subject matter described in this specification can be embodied in methods that include the actions of displaying in a text entry box of a user interface, a first n-gram representing a sequence of characters entered by a user; in response to receiving a selection of a character from a plurality of characters displayed in a virtual representation of an input device displayed in the user interface, concatenating the selected character to the end of the first n-gram to produce a second n-gram; comparing the second n-gram to n-grams stored in a language model directed to a particular program application associated with the text entry box to identify input suggestions for the second n-gram; generating selectable suggestions from the identified input suggestions; and displaying the selectable suggestions proximate to the selected character in the virtual representation of the input device. Other embodiments of this aspect include corresponding systems, apparatus, and computer program products.

The foregoing and following embodiments can optionally include one or more of the following features. Generating selectable suggestions from the identified input suggestions includes ranking each identified input suggestion based on a distance between the selected character and a next character that corresponds to a first character in the identified input suggestion. The distance is based on a number of activations of input controls required to move from the selected character to the next character. The method further includes in response to receiving a selection of a function key displayed in the virtual representation of the input device, modifying the sequence of characters using a function corresponding to the selected function key to produce a third n-gram; comparing the third n-gram to n-grams stored in the language model to identify input suggestions for the third n-gram; generating selectable suggestions from the identified input suggestions; and displaying the selectable suggestions proximate to the selected function key in the virtual representation of the input device.

Particular embodiments of the subject matter described in this specification can be implemented to realize one or more of the following advantages. Providing predictive text functionally to an input device reduces how much user interaction is required for text entry. For example, presenting selectable suggestions, e.g., predictive text, proximate to a currently indicated key (or character) on an onscreen keyboard reduces how much user interaction is required to locate and select a target key corresponding to the selectable suggestion. The selectable suggestions can be generated from a custom language model, e.g., a language model directed to a particular user or program application. As a result, the amount of user interaction can be further reduced because the selectable suggestions are more likely to be relevant to the particular user or program application. In addition to saving time, reducing user interaction can reduce the likelihood of user mistakes, e.g., including misspellings and navigational errors.

Furthermore, smaller virtual input devices can be used for input, thereby increasing an amount of space (i.e., “screen real estate”) on an electronic device's display that can be used to display other content.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram illustrating an example of a flow of data in some implementations of a system in which input devices have predictive text entry functionality.

FIG. 2 is a block diagram illustrating an example selectable suggestion generator.

FIG. 3A is a screenshot illustrating an example user interface showing a text entry box and a virtual input device.

FIG. 3B is an example arrangement of input controls for navigating to and selecting input objects on a virtual input device.

FIG. 3C is a screenshot illustrating the example user interface of FIG. 3A, where the virtual input device includes selectable suggestions associated with an indicated character.

FIG. 3D is a screenshot illustrating the example user interface of FIG. 3C, where the indicator is associated with a second character.

FIG. 3E is a screenshot illustrating the example user interface of FIG. 3D, where the virtual input device includes different types of selectable suggestions associated with the second character.

FIG. 4A is an example arrangement of selectable suggestions around an indicated character.

FIG. 4B is another example arrangement of selectable suggestions around an indicated character.

FIG. 5 is a flow chart showing an example process for providing predictive text functionality to input devices.

Like reference numbers and designations in the various drawings indicate like elements.

### DETAILED DESCRIPTION

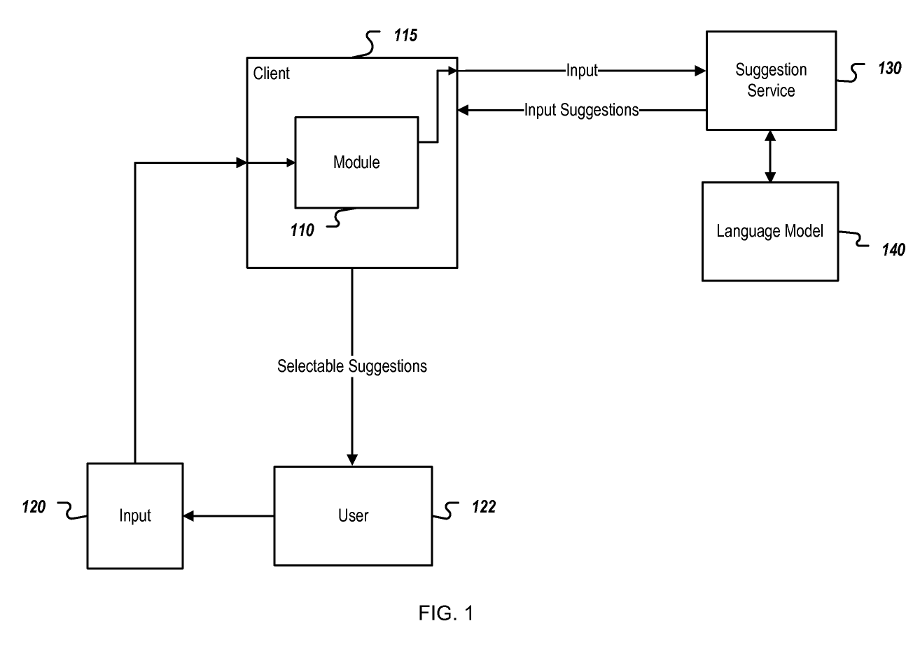

FIG. 1 is a block diagram illustrating an example of a flow of data in some implementations of a system in which input devices have predictive text entry functionality. A module 110, e.g., a software script, installed on a client 115 monitors input 120 received in a text entry field from a user 122. In some implementations, the module 110 is plug-in software that is installed in a particular program application, running on the client 115. Example program applications include text browsers or editors (e.g., a chat application, word processor, email client application, web browser, browser for a digital video recorder (DVR), or input method editor (IME)). In some alternative implementations, the module 110 is installed on a server (which may be an intermediate server) that receives the input 120.

The module 110 receives the input 120 and automatically sends the input 120 to a suggestion service 130. In some implementations, the suggestion service 130 runs on the client 115. For example, the suggestion service 130 can be a component of module 110. The suggestion service 130 returns one or more input suggestions that can be used as alternatives to the input 120. For example, the input suggestions can be expansions, completions, translations, or transliterations of the input 120.

The input suggestions can be ranked based on one or more criteria. The input suggestions are sent to a language model 140 to calculate likelihoods of the input suggestions. In some implementations, the language model 140 can also be stored on the client 115 and updated periodically or in response to a user request. The likelihoods of the input suggestions occurring can be used as a criterion to rank the input suggestions. The rankings of the input suggestions are used to identify which input suggestions are used to generate selectable suggestions. Ideally, the selectable suggestions predict a next input that the user intends to enter.

The likelihoods of the input suggestions occurring can be identified using a language model. The probability according to a language model that a particular string (e.g., an input suggestion) will occur can be determined using the chain rule. The chain rule determines a probability of a string as a product of individual probabilities. Thus, for a given string “e₁, e₂, . . . , eₖ”, the probability for the string, p(e₁, e₂, . . . eₖ), is equal to:

$${\prod }_{i = 1}^{k} p ( {e}_{i} \vert {e}_{1} , … , {e}_{i - 1} ) .$$

The language model can be limited to a particular maximum size n-gram, e.g., limited to 1-grams, 2-grams, 3-grams. An n-gram is a sequence of n consecutive tokens, e.g., characters or words. An n-gram has an order, which is a number of tokens in the n-gram. For example, a 1-gram (or unigram) includes one token; a 2-gram (or bi-gram) includes two tokens. As an example where a token is a word, “Hello world” is a 2-gram. An example 3-gram where a token is a character is “Hel”.

For a given string, e.g., “NASA officials say they hope,” where the maximum n-gram order is limited to 3-grams (e.g., three words), the probability for the string can be determined as a product of conditional probabilities as follows: p(NASA officials say they hope)=p(NASA)·p(officials|NASA)·p(say·NASA officials)·p(they|officials say)·p(hope|say they). This can be generalized to:

$$p ( {e}_{1} , … , {e}_{k} ) = {\prod }_{i = 1}^{k} p ( {e}_{i} \vert {e}_{i - n + 1} , … , {e}_{i - 1} ) ,$$

where n is the order of the largest n-gram allowed in the language model.

The conditional probabilities are generally determined empirically, according to relative frequencies in the documents of training data. In the example above, the probability of the word “say” given the context of “NASA officials” is given by:

$$p ( say \vert NASA officials ) = \frac{f ( NASA officials say )}{f ( NASA officials )} ,$$

where f (NASA officials say) is a frequency or a count of the occurrences of the string “NASA officials say” in the documents of the training data. Conditional probabilities for strings within the maximum n-gram order in the n-gram language model correspond to the probability stored in the language model for the n-gram, e.g., p(say|NASA officials) is the conditional probability stored in the language model for the 3-gram entry “NASA officials say”.

In some implementations, the language model can be a custom language model directed to a particular program application or user. The custom language model can be trained using training data associated with the particular program application. The training data can include different sets of data that are associated with the particular program application. As an example, if the program application is a browser for a DVR, the training data includes a first set of texts relevant to television shows and movies and a second set of texts relevant to television channels. As another example, if the program application is a chat application, the training data can include chat logs of a particular user using the chat application. In addition, the custom language model can be trained using input patterns of the particular user. For example, if the user enters a television show about sports, rankings of input suggestions relevant to sports can be increased.

Other implementations are possible. For example, the custom language model can be directed to a particular natural language (e.g., Chinese, Japanese, Hindi). In some implementations, the user 122 can specify a particular suggestion service or a particular language model to be used by setting user preferences.

The suggestion service 130 can determine the one or more input suggestions and their rankings using a language model. The module 110 receives the input suggestions from the suggestion service 130. The module 110 processes the input suggestions and sends selectable suggestions (e.g., character suggestions, or portions of the input suggestions) to the user 122. The module 110 can present the selectable suggestions to the user in a manner that reduces a distance between the selectable suggestion (e.g., a character suggestion) and a currently indicated input object (e.g., a highlighted key or character on an onscreen keyboard). In particular, the module 110 can superimpose the selectable suggestions on a virtual input device, e.g., an onscreen keyboard, at the location of the currently indicated key, so that the user can more efficiently navigate and select one of the selectable suggestions.

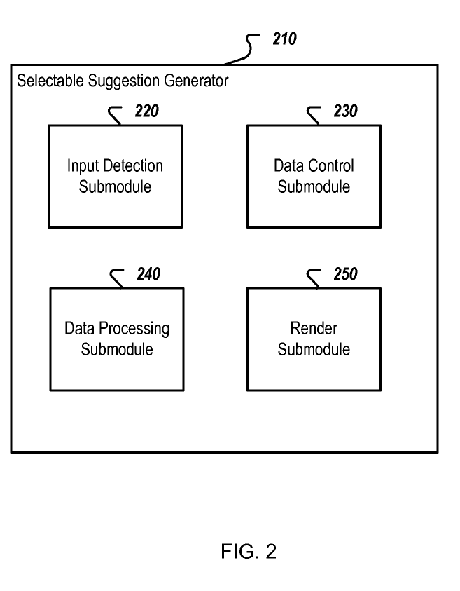

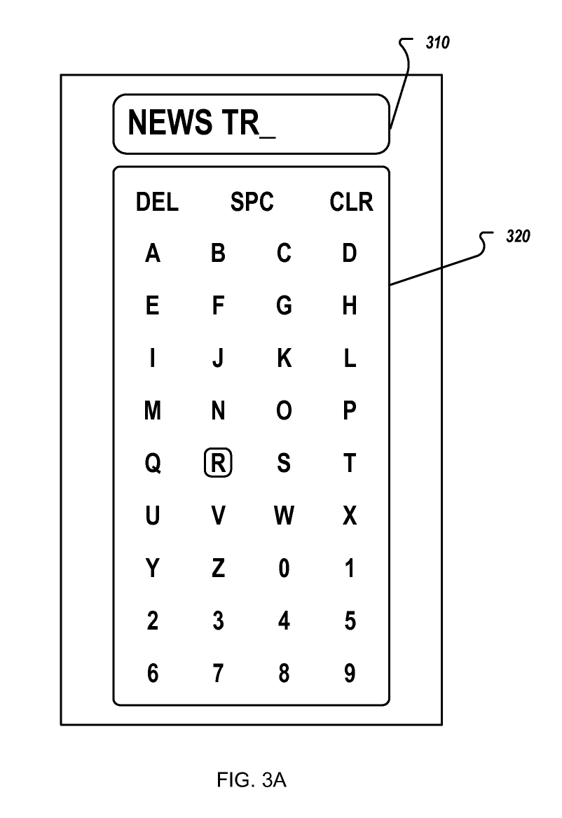

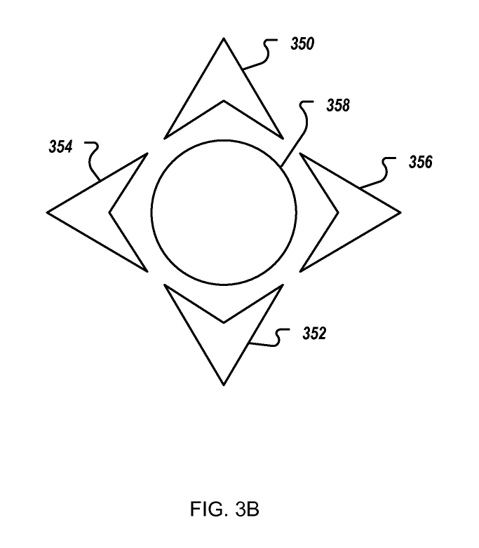

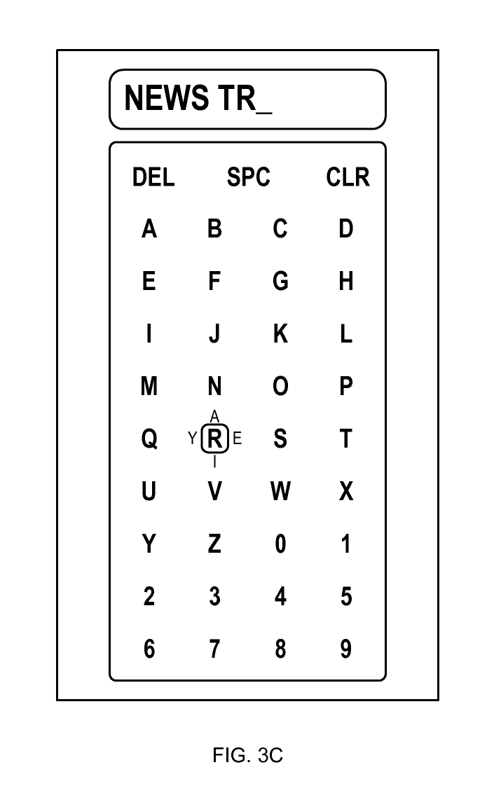

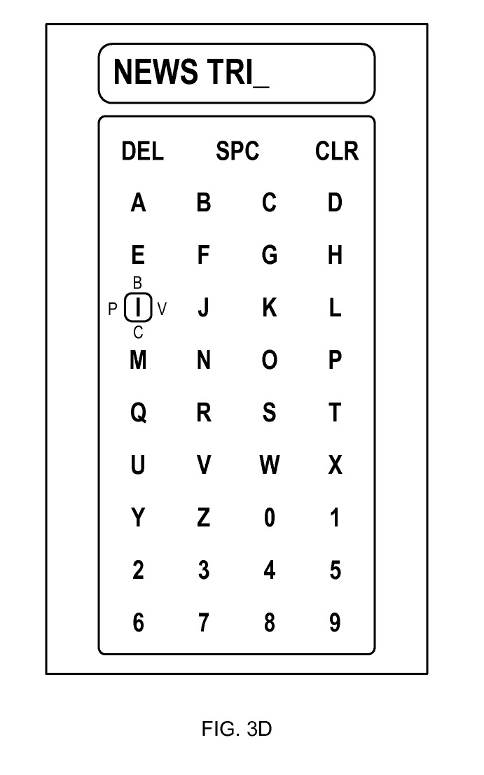

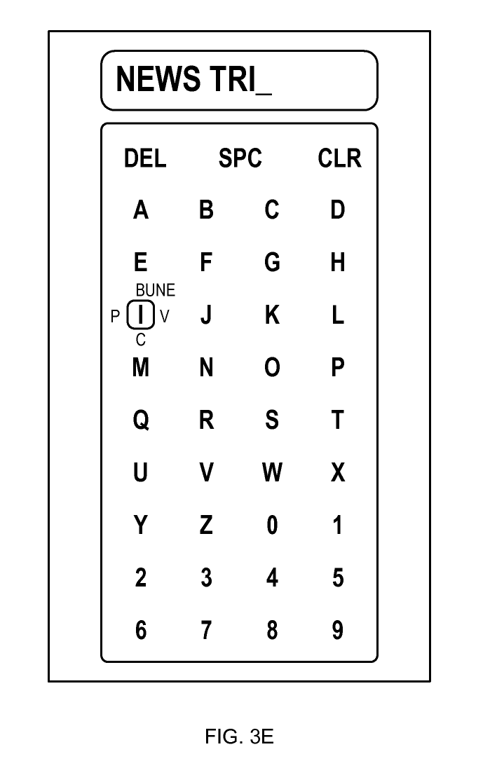

FIG. 2 is a block diagram illustrating an example selectable suggestion generator 210. The selectable suggestion generator 210 includes an input detection submodule 220, a data control submodule 230, a data processing submodule 240, and a render submodule 250. The input detection submodule 220 detects input entered in a text entry field of a user interface (e.g., text entry box 310 in FIG. 3A).

The data control submodule 230 communicates with a suggestion service (e.g., suggestion service 130). In particular, the data control submodule 230 sends to the suggestion service requests, e.g., Hypertext Transfer Protocol (HTTP) requests, for input suggestions. The data control submodule 230 receives input suggestions from the suggestion service and sends the input suggestions to the data processing submodule 240.

In some implementations, the suggestion service returns character suggestions, i.e., single characters, as input suggestions. In some implementations, the suggestion service returns input suggestions that include more than one character. The data processing submodule 240 processes the input suggestions to generate selectable suggestions. The data processing submodule 240 identifies a next character as being a selectable suggestion based on the rankings of the input suggestions that include more than one character. For example, if the selectable suggestions include the n-grams “NEWS TRANSCRIPT” with a 50% likelihood of occurring, “NEWS TRAFFIC” with a 30% likelihood of occurring, and “NEWS TRIBUNE” with a 20% likelihood of occurring, then the likelihood of “NEWS TRA” occurring can be assigned the probability 80% (i.e., 50%+30%). The likelihood of “NEWS TRI” occurring can be assigned the probability 20%. The data processing submodule can identify “A”, i.e., the last character of “NEWS TRA” as being the most likely selectable suggestion since “A” is more likely than “I” to be the next character in the sequence “NEWS TR”.

FIG. 3A is a screenshot illustrating an example user interface showing a text entry box 310 and a virtual input device 320, e.g., an onscreen keyboard. The text entry box 310 includes a textual input “NEWS TR”. The virtual input device 320 includes the function keys: delete (“DEL”) and clear (“CLR”). The virtual input device 320 also includes alphanumeric keys (“A”-“B”, and “0”-“9”) and a space (“SPC”) key. A user can interact with the virtual input device to enter text in the text entry box 310.

FIG. 3B is an example arrangement of input controls for navigating to and selecting input objects on a virtual input device. Such arrangements of input controls can be found on physical input devices. Examples of physical input devices include keyboards, universal remote controls, gaming devices (e.g., video game controllers, handheld game consoles, and portable media players), mobile devices (e.g., cellular phones, smart phones), and car input controls. In some implementations, the arrangement of input controls is used in a virtual input device, e.g., a virtual representation of the input controls presented on a touchscreen display.

The input controls can be used to move an indicator (e.g., a cursor) around a virtual input device. In particular, the input controls include directional controls: “Up” control 350, a “Down” control 352, a “Left” control 354, and a “Right” control 356. The directional controls can be used to move the indicator in a corresponding direction on the virtual input device to select an input object on the virtual input device. The input controls also include an activation control 358, e.g., an “Enter” control. In some implementations, the activation control 358 is used to select, e.g., submit the selection, of a currently indicated input object in the virtual input device.

Returning to FIG. 3A, an indicator is associated with the character “R” (a box around the key labeled “R”). Activating, e.g., a user pushing or pressing, the “Up” control 350 moves the indicator to the character “N”. Alternatively, activating the “Down” control 352 moves the indicator to the character “V”, activating the “Left” control 354 moves the indicator to the character “Q”, and activating the “Right” control 356 moves the indicator to the character “S”. Activating the activation control 358 confirms the selection of the selected character, e.g., submits the character “R” as the next character to be entered in text entry box 310.

Other implementations are possible. For example, haptic controls can be used to navigate through the input objects of the virtual input device.

FIG. 3C is a screenshot illustrating the example user interface of FIG. 3A, where the virtual input device includes selectable suggestions associated with an indicated character. In the example, a user previously submitted the character “R” as a portion of the textual input displayed in the text entry box 310, i.e., the last character in the sequence “NEWS TR” is the character “R”. The indicator remains on the most recently submitted character “R”.

After the input detection submodule 220 detects input entered in the text entry box 310 and before the user submits the textual input (e.g., “NEWS TR”) for a search, the data control submodule 230 sends a request, including the textual input, to the suggestion service 130. The suggestion service 130 determines input suggestions and returns input suggestions (and rankings of the input suggestions) to the selectable suggestion generator 210. Examples of input suggestions for the textual input “NEWS TR” include “NEWS TRIBUNE”, “NEWS TRANSCRIPT”, “NEWS TRIB”, “NEWS TRENDS”, and “NEWS TRUST”.

The selectable suggestion generator 210 generates selectable suggestions based on the rankings of the input suggestions. For example, the selectable suggestions can be ranked based on likelihood of occurrence, where a first selectable suggestion that is more likely to occur than a second selectable suggestion is ranked higher than the second selectable suggestion. Based on further processing of the input suggestions and the rankings of the input suggestions, the selectable suggestion generator 210 may determine, for example, that “NEWS TRA” is more likely to occur than “NEWS TRE”, and “NEWS TRE” is more likely to occur than “NEWS TRI”.

In some implementations, the selectable suggestion generator 210 generates selectable suggestions that are character suggestions. A character suggestion is a single character that is predicted to be the next possible character that the user desires to enter in the textual input. Returning to the previous example, the selectable suggestion generator 210 may determine that the character suggestion “A” (i.e., the character following “R” in “NEWS TRA”) is more likely to occur than the character “E” (i.e., the character following “R” in “NEWS TRE”).

The selectable suggestions can be presented in an arrangement proximate to the selected input object based on the rankings. For example, the highest ranked selectable suggestion (e.g., “A”) can be presented proximate to the selected input object such that it can be accessed by activating the “Up” control 350. The second highest ranked selectable suggestion (e.g., “E”) can be presented such that it can be accessed by activating the “RIGHT” control 356, the third highest ranked selectable suggestion (e.g., “I”) can be presented such that it can be accessed by activating the “Down” control 352, and the fourth highest ranked selectable suggestion (e.g., “Y”) can be presented such that it can be accessed by activating the “Left” control 354.

By presenting selectable suggestions proximate to a currently indicated input object, the distance required to navigate to a target input object from the currently indicated input object can be reduced without significantly distorting the layout of the virtual input device (e.g., the original layout continues to be displayed). For example, if the user intended to enter “I” as a next character in the sequence of the textual input “NEWS TR”, the user can activate the “Down” control 352 followed by the activation control 358 to confirm entering the selectable suggestion “I”. Without the selectable suggestion “I”, a user activates the “Up” control 350 two times and then activates the “Left” control 354 to pass through the characters “N” and “J” and associate the indicator with “I”. Then, the user activates the activation control 358 to enter “I”.

In situations where the user desires to enter an input different from the selectable suggestions that are presented, only one additional activation is required to pass through one of the selectable suggestions to select the desired input. For example, if the user wants to enter the character “V”, the user can activate the “Down” control 352 two times to pass through the character “I” and associate the indicator with the character “V”.

In some implementations, the arrangement in which the selectable suggestions are presented can be specified by user preference. For example, the user can specify that the highest ranked selectable suggestion be presented such that an activation of the “Down” control 352 associates the indicator with the highest ranked selectable suggestion.

FIG. 3D is a screenshot illustrating the example user interface of FIG. 3C, where the indicator is associated with a second character. In particular, in the state of the virtual input device shown in FIG. 3C, if the user activates the “Down” control 352 followed by the activation control 358, the character “I” is selected and submitted as a next character in the textual input displayed in the text entry box 310. After the submission, the indicator is moved from the selectable suggestion represented by the character “I” presented below the character “R” to the alphabetic key representing the character “I” in the row of characters “I J K L” in the virtual input device. As described with respect to FIG. 3C, the selectable suggestion generator generates selectable suggestions using the textual input (e.g., “NEWS TRI”) and presents the selectable suggestions (e.g., “B”, “V”, “C”, and “P”) proximate to the indicated character.

If the user submits a selection of a function key, the textual input displayed in the text entry box 310 can be modified based on a function corresponding to the function key. Selectable suggestions can also be presented proximate to the selected function key. For example, in the state of the virtual input device shown in FIG. 3D, if the user activates the “Up” control 350 three times and the activation control 358, the delete function (corresponding to the “DEL” key) is performed. The character “I” in the textual input displayed in the text entry box 310 is deleted. As a result, the textual input displayed in the text entry box 310 becomes “NEW TR”.

Selectable suggestions can be generated based on the selected function key. In the example, the selected function key modifies the textual input, and the selectable suggestions can be generated from the modified textual input. In the example, the selectable suggestions “A”, “E”, “I”, and “Y” can presented proximate to the “DEL” key in an arrangement similar to how the selectable suggestions “A”, “E”, “I”, and “Y” are presented around the character “R” in FIG. 3C. The user can also interact with the selectable suggestions presented proximate to the “DEL” key in a similar manner as described above with respect to FIG. 3C and FIG. 3D.

In some implementations, the selectable suggestion generator 210 generates selectable suggestions that include more than one character.

FIG. 3E is a screenshot illustrating the example user interface of FIG. 3D, where the virtual input device includes different types of selectable suggestions associated with the second character. In some implementations, if the likelihood of an input suggestion occurring is greater than a threshold value, the selectable suggestion generator 210 presents selectable suggestions that include more than one character. For example, the selectable suggestion generator 210 can present a completion of the current textual input. In FIG. 3E, the textual input includes the sequence of characters “NEWS TRI”. The selectable suggestion generator 210 may receive an input suggestion (e.g., “NEWS TRIBUNE”) that has a likelihood of occurring that is greater than a predetermined likelihood of occurring (e.g., a likelihood greater than 95% chance of occurring) and present the n-gram “BUNE” instead of a character suggestion consisting of the character “B”. Concatenating the n-gram “BUNE” to the sequence of characters “NEWS TRI” produces a completion “NEWS TRIBUNE”. In some implementations, if the likelihood of an input suggestion occurring is within a standard deviation of the mean of the likelihoods of the selectable suggestions occurring, the selectable suggestion generator 210 presents a selectable suggestion that corresponds to the input suggestion, which includes more than one character.

In some implementations, the selectable suggestion generator 210 presents an input suggestion as a selectable input suggestion. For example, the selectable suggestion generator 210 can present “NEWS TRIBUNE” instead of the n-gram “BUNE” in FIG. 3E. In response to a user selection of the selectable input suggestion “NEWS TRIBUNE”, the textual input is updated to include the sequence of characters “NEWS TRIBUNE”. In some implementations, a skiplist, e.g., a list of completions presented in a drop down menu, is presented instead of the n-gram “BUNE” in FIG. 3E. In some implementations, the skiplist is presented in a separate user interface element (e.g., a window). Instead of the n-gram “BUNE” in FIG. 3E, the selectable suggestion generator 210 can present a key, e.g., a key labeled “skiplist”. A user selection of the “skiplist” key moves the indicator to the skiplist so that the user can select the items in the skiplist. In addition, in the virtual input device, numbers can be associated with each of the selectable suggestions, e.g., the selectable suggestions are presented as a numbered list, so that a user can select a selectable suggestion by entering the associated number using a physical input device.

In some implementations, the selectable suggestion generator 210 presents a command key rather than one or more characters or an input suggestion as a selectable input suggestion. Returning to FIG. 3C, for example, the selectable suggestion generator 210 can present a command key such as a search key or a return key as a selectable input suggestion. For example, the selectable suggestion generator 210 can present a key labeled “search” instead of the character “Y” in FIG. 3C. In response to a user selection of the “search” selectable input suggestion, a search (e.g., of television programs) is initiated using the existing textual input. In general, a command key is a key that, when selected, causes a command to be performed by the electronic device that provides the virtual input device.

In some implementations, more than four selectable input suggestions can be presented. For example, the directional controls shown in FIG. 3B can be used to move an indicator in a corresponding direction on a virtual input device to navigate to and select the input suggestions.

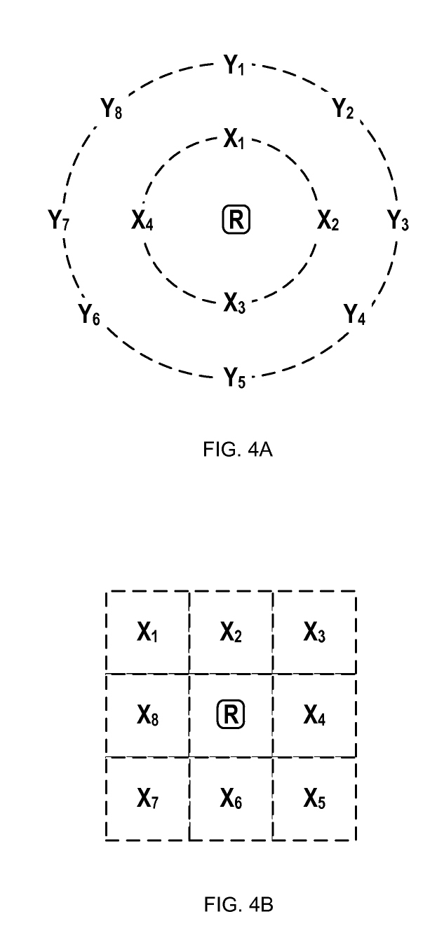

FIG. 4A is an example arrangement of selectable suggestions around an indicated character, e.g., the character “R”. In particular, the selectable suggestions are presented in an arrangement that forms concentric circles around the indicated character located at the center. Note that, for simplicity, FIG. 4A only shows the indicated character of the virtual input device and not the entire virtual input device. In practice, the selectable suggestions can be superimposed on the virtual input device, that includes other characters (e.g., “A”-“Q”, “S”-“Z”, and “0”-“9”), and the dotted lines are not displayed.

The selectable suggestions X₁, X₂, X₃, and X₄ are presented in the formation of a first concentric circle and the selectable suggestions Y₁, Y₂, Y₃, Y₄, Y₅, Y₆, Y₇, and Y₈ are presented in the formation of a second concentric circle, where the radial distance from the center to X₁, X₂, X₃, and X₄ is less than the radial distance from the center to Y₁, Y₂, Y₃, Y₄, Y₅, Y₆, Y₇, and Y₈. The selectable suggestions X₁, X₂, X₃, and X₄ are ranked higher (e.g., are more likely to occur) than the selectable suggestions Y₁, Y₂, Y₃, Y₄, Y₅, Y₆, Y₇, and Y₈.

A user can move the indicator to select the selectable suggestions in a manner similar to the manner described above with reference to FIG. 3B and FIG. 3C. For example, if the indicator is associated with X₁, the user can activate the “Up” control to move the indicator to Y₁. From Y₁, the user can move the indicator to Y₂ by activating the “RIGHT” control. In addition, when the indicator is associated with Y₂, the “Down” control can be mapped such that the indicator moves to or X₂ or Y₃, depending on user preference.

FIG. 4B is another example arrangement of selectable suggestions around an indicated character. In this example, the indicated character “R” and the selectable suggestions X₁, X₂, X₃, X₄ and X₅ are arranged in a grid. Note that, for simplicity, FIG. 4B only shows the indicated character of the virtual input device and not the complete virtual input device. In practice, the selectable suggestions are superimposed on the virtual input device, that includes other characters (e.g., “A”-“Q”, “S”-“Z”, and “0”-“9”), and the dotted lines are not displayed. A user can move the indicator to select the selectable suggestions as described above with reference to FIG. 3B and FIG. 3C. Other arrangements are possible.

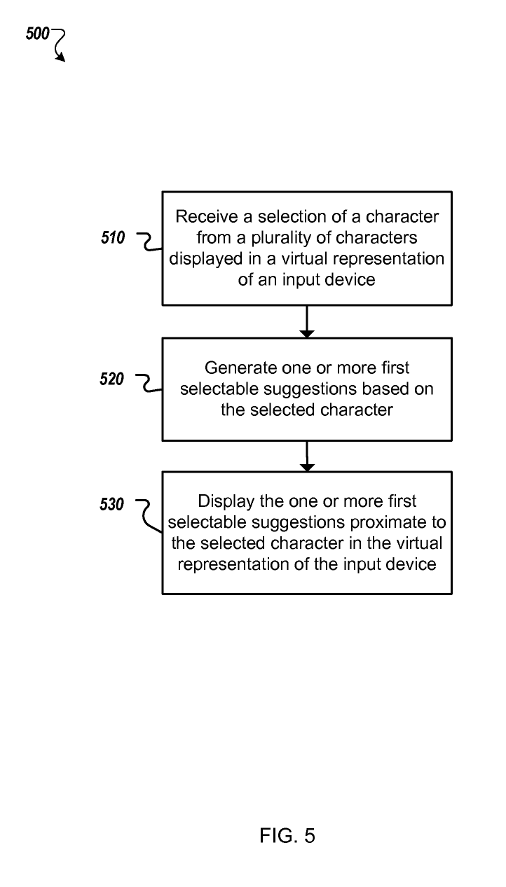

FIG. 5 is a flow chart showing an example process 500 for providing predictive text functionality to input devices. The process includes receiving 510 a selection of a character from a plurality of characters displayed in a virtual representation of an input device. The process also includes generating 520 one or more first selectable suggestions based on the selected character. The process also includes displaying 530 the one or more first selectable suggestions proximate to the selected character in the virtual representation of the input device.

Other implementations of the systems and techniques for modifying input devices to include predictive text entry functionality are possible. In some implementations, the ranking of a selectable suggestion can be based on a likelihood of occurrence and a distance measure. For example, the distance measure can represent the distance, on a virtual input device, between a currently indicated character to a next character that corresponds to the first character in the sequence of characters in the selectable suggestion. Returning to FIG. 3A, for example, if the currently indicated character is “R” and the highest ranked and second highest ranked selectable suggestions are “U” and “A”, respectively, the ranking of selectable suggestion “A” can be modified (e.g., increased) based on its distance from the currently indicated character. In particular, without input suggestions, the indicator can be moved to “U” using two activations of input controls (e.g., “Down”+“Left”), while the indicator can be moved to “A” using five activations of input controls (e.g., “Up”+“Up”+“Up”+“Up”+“Left”). The ranking for the selectable suggestion “A” can be increased based on the difference in distance measures (e.g., three extra activations) so that “A” has a higher ranking than “U”.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus. The tangible program carrier can be a computer-readable medium. The computer-readable medium can be a machine-readable storage device, a machine-readable storage substrate, a memory device, or a combination of one or more of them.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program, also known as a program, software, software application, script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described is this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter described in this specification have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A method comprising:
receiving a selection of a first character from a plurality of characters displayed in a virtual representation of an input device;
generating one or more first selectable suggestions based on the first character; and
displaying the one or more first selectable suggestions proximate to the first character in the virtual representation of the input device, wherein the first selectable suggestions are displayed closer to the first character than any of the plurality of characters normally displayed in the virtual representation of the input device.

2. The method of claim 1, where the first selectable suggestions include input completions.

3. The method of claim 1, where a selectable suggestion is a single character.

4. The method of claim 1, where a selectable suggestion is a sequence of characters.

5. The method of claim 1, where:
the first character is displayed as one of a grid of characters in the virtual representation, and the characters in the grid are displayed separated from each other by blank space; and the suggestions are displayed in otherwise blank space in the virtual representation of the input device.

6. The method of claim 1, where:
the plurality of characters are displayed on two axes on the virtual representation of an input device and the first selectable suggestions are displayed on the two axes.

7. The method of claim 1, where:
the first selectable suggestions are displayed until a selection is received of one of the first selectable suggestions or a selection is received of one of the characters displayed in the virtual representation of an input device.

8. The method of claim 1, further comprising:
receiving a selection of a function key displayed in the virtual representation of the input device;
generating one or more second selectable suggestions based on the selected function key; and
displaying the one or more second selectable suggestions proximate to the selected function key in the virtual representation of the input device.

9. The method of claim 1, further comprising:
receiving a selection of one of the first selectable suggestions;
generating one or more second selectable suggestions based on the first selectable suggestion that was selected; and
displaying the one or more second selectable suggestions proximate to a character in the virtual representation of the input device, where the first selectable suggestion that was selected is a sequence of characters, and the character which the one or more second selectable suggestions is displayed proximate to corresponds to a last character in the sequence of characters of the first selectable suggestion that was selected.

10. The method of claim 9, where:
receiving a selection of one of the first selectable suggestions comprises receiving a navigation input navigating from the representation of the first character in the virtual representation to one of the first selectable suggestions in the virtual representation.

11. A method comprising:
receiving a selection of a key displayed in a virtual representation of an input device;
generating one or more selectable suggestions based on a character or function that corresponds to the key; and
displaying the selectable suggestions proximate to the selected key in the virtual representation of the input device.

12. A method comprising:
displaying in a text entry box of a user interface, a first n-gram representing a sequence of characters entered by a user;
in response to receiving a selection of a character from a plurality of characters displayed in a virtual representation of an input device displayed in the user interface, concatenating the selected character to the end of the first n-gram to produce a second n-gram;
comparing the second n-gram to n-grams stored in a language model directed to a particular program application associated with the text entry box to identify input suggestions for the second n-gram;
generating selectable suggestions from the identified input suggestions; and
displaying the selectable suggestions proximate to the selected character in the virtual representation of the input device.

13. The method of claim 12, further comprising:
in response to receiving a selection of a function key displayed in the virtual representation of the input device, modifying the sequence of characters using a function corresponding to the selected function key to produce a third n-gram;
comparing the third n-gram to n-grams stored in the language model to identify input suggestions for the third n-gram;
generating selectable suggestions from the identified input suggestions; and
displaying the selectable suggestions proximate to the selected function key in the virtual representation of the input device.

14. The method of claim 12, where generating selectable suggestions from the identified input suggestions includes ranking each identified input suggestion based on a distance between the selected character and a next character that corresponds to a first character in the identified input suggestion.

15. The method of claim 14, where the distance is based on a number of activations of input controls required to move from the selected character to the next character.

16. A computer program product, stored on a computer-readable medium, operable to cause data processing apparatus to perform operations comprising:
receiving a selection of a first character from a plurality of characters displayed in a virtual representation of an input device;
generating one or more first selectable suggestions based on the first character; and
displaying the one or more first selectable suggestions proximate to the first character in the virtual representation of the input device, wherein the first selectable suggestions are displayed closer to the first character than any of the plurality of characters normally displayed in the virtual representation of the input device.

17. A computer program product, stored on a computer-readable medium, operable to cause data processing apparatus to perform operations comprising:
receiving a selection of a key displayed in a virtual representation of an input device;
generating one or more selectable suggestions based on a character or function that corresponds to the key; and
displaying the selectable suggestions proximate to the selected key in the virtual representation of the input device.

18. A computer program product, stored on a computer-readable medium, operable to cause data processing apparatus to perform operations comprising:
displaying in a text entry box of a user interface, a first n-gram representing a sequence of characters entered by a user;
in response to receiving a selection of a character from a plurality of characters displayed in a virtual representation of an input device displayed in the user interface, concatenating the selected character to the end of the first n-gram to produce a second n-gram;
comparing the second n-gram to n-grams stored in a language model directed to a particular program application associated with the text entry box to identify input suggestions for the second n-gram;
generating selectable suggestions from the identified input suggestions; and
displaying the selectable suggestions proximate to the selected character in the virtual representation of the input device.

19. A system comprising:
a display device;
a machine-readable storage device including a program product; and
one or more processors operable to execute the program product, interact with the display device, and perform operations comprising:
receiving a selection of a first character from a plurality of characters displayed in a virtual representation of an input device;
generating one or more first selectable suggestions based on the first character; and
displaying the one or more first selectable suggestions proximate to the first character in the virtual representation of the input device, wherein the first selectable suggestions are displayed closer to the first character than any of the plurality of characters normally displayed in the virtual representation of the input device.

20. A system comprising:
a display device;
a machine-readable storage device including a program product; and
one or more processors operable to execute the program product, interact with the display device, and perform operations comprising:
receiving a selection of a key displayed in a virtual representation of an input device;
generating one or more selectable suggestions based on a character or function that corresponds to the key; and
displaying the selectable suggestions proximate to the selected key in the virtual representation of the input device.

21. A system comprising:
a display device;
a machine-readable storage device including a program product; and
one or more processors operable to execute the program product, interact with the display device, and perform operations comprising:
displaying in a text entry box of a user interface, a first n-gram representing a sequence of characters entered by a user;
in response to receiving a selection of a character from a plurality of characters displayed in a virtual representation of an input device displayed in the user interface, concatenating the selected character to the end of the first n-gram to produce a second n-gram;
comparing the second n-gram to n-grams stored in a language model directed to a particular program application associated with the text entry box to identify input suggestions for the second n-gram;
generating selectable suggestions from the identified input suggestions; and
displaying the selectable suggestions proximate to the selected character in the virtual representation of the input device.
